(19) United States
(12) Patent Application Publication
(10) Pub. No.: US 2008/0309701 A1
(43) Pub. Date: Dec. 18, 2008

(54) Ink Jet Device for Releasing Controllably a Plurality of Substances Onto a Substrate, Method of Discrimination Between a Plurality of Substances and Use of an Ink Jet Device

(75) Inventors: Anke Pierik, Eindhoven (NL); Johan Frederik Dijksman, Weert (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,047

(22) PCT Filed: Nov. 24, 2006
(86) PCT No.: PCT/IB2006/054424

§ 371 Date: May 27, 2008

(30) Foreign Application Priority Data
Nov. 28, 2005 (EP) 05111354.6

(51) Int. Cl. B41J 29/393

(52) U.S. Cl. 347/19

(57) ABSTRACT

The invention provides an ink jet device for releasing controllably a plurality of substances onto a substrate, the device comprising at least a print head comprising a nozzle, the device comprising at least a transducer provided to eject a droplet out of the nozzle, wherein a detection means is assigned to the ink jet device such that the substances are discriminable from each other by means of the detection of the behaviour of the transducer.

The present invention relates to an ink jet device for releasing controllably a plurality of substances onto a substrate. The present invention further relates to a method of discriminating between a plurality of substances using an ink jet device. The present invention further relates to the use of an ink jet device.

The present invention discloses an ink jet device for releasing controllably a plurality of substances onto a substrate, a method and the use of an ink jet device. Especially for diagnostics, substrates are needed where a plurality of different substances are positioned in a very precise and accurate manner. This plurality of substances usually are to be positioned on a substrate in order to perform a multitude of biochemical tests or reactions on the substrate. The ink jet device, the method of controlled positioning of droplets of a substance and the use of an ink jet device according to the present invention are preferably applied to the printing process of substances onto a substrate, where it may be extremely hazardous if a substance of a certain kind is applied wrongly onto a certain region of the substrate.

Ink jet devices are generally known. For example, European patent applications EP 1378359 A1, EP 1378360 A1, EP 1378361 A1 disclose methods of controlling an inkjet print head containing ink, in which an actuation pulse is applied by an electromagnetic transducer in order to eject an ink drop or droplet out of a duct, wherein an electronic circuit is used to measure the impedance of the electromagnetic transducer and to adapt the actuation pulse or a subsequent actuation pulse. One drawback of the known method is that no indication is possible as to whether the ink or printing fluid is appropriate. This strongly limits the reliability of the printing or ink jet device, especially for applications where a reliable printing process using a plurality of different substances is essential.

It is therefore an objective of the present invention to provide an ink jet device for releasing controllably a plurality of substances onto a substrate, which ink jet device has a higher degree of reliability while handling a plurality of different printing fluids or substances to be printed.

The above objective is accomplished by an ink jet device for releasing controllably a plurality of substances onto a substrate, by a method of discriminating between a plurality of substances according to the present invention and by the use of an ink jet device according to the present invention. The ink jet device for releasing controllably a plurality of substances onto a substrate comprises at least a print head having a nozzle, and the device further comprises at least a transducer provided to eject a droplet out of the nozzle, wherein a detection means is assigned to the ink jet device such that the substances are discriminable from each other by means of the detection of the behaviour of the transducer.

It is an advantage of the ink jet device according to the present invention that a multitude of different substances are discriminable by means of a measurement of the behaviour of the transducer and/or of the transducer comprising the substance. The transducer is a—preferably electromechanical—transducer applying mechanical and hydro-acoustic waves into the print head. The print head is preferably an almost closed volume at least partially filled with the liquid to be printed, i.e. the substance to be printed. The print head comprises at least one opening or a duct where, upon an actuation pulse, at least a part of the liquid contained in the print head can be expelled or ejected forming outside of the print head a droplet of the liquid. In the following, the opening or the duct is also called a nozzle in the context of the present invention. By applying mechanical and hydro-acoustic waves into the print head filled with the liquid to be printed, the system comprising the print head and the liquid reacts in a different manner if different liquids or substances are used inside the print head. Therefore, by measuring the behaviour of the transducer, which is indicative of the behaviour of the print head and/or of the behaviour of the system comprising the print head and the substance inside the print head, it is possible to measure a property of the liquid or the substance with a certain tolerance or accuracy. If different liquids or substances are used within the print head with a different value of that property, it is possible to discriminate between these liquids or substances. Discrimination is possible if the values of the measured property are spaced further apart than the possible accuracy of the measurement of the property.

According to the present invention, it is very much preferred that the substances are discriminable from each other by means of a measurement of the viscosity of the substances. The measurement of the viscosity is relatively easy and can be performed with a relatively high accuracy.

Very preferably, according to the present invention, the transducer is a piezoelectric transducer. As a result, it is especially possible to use the same transducer for ejecting the droplets and for measuring the behaviour of the fluid inside the print head.

Still preferably, according to the present invention, the detection means is an electronic detection circuit assigned to the ink jet device, or the detection means is detection software assigned to the ink jet device. It is thus possible to implement the measuring of the behaviour of the transducer and/or the behaviour of the fluid inside the print head by providing a detection circuit and/or by providing a software module detecting the behaviour of the print head. The detection circuit and/or the detection software module can either be provided inside the ink jet device, i.e. the ink jet device comprises the circuit and/or the software module. In another embodiment of the present invention, the detection circuit and/or the detection software module is not comprised by the ink jet device, but the detection circuit and/or the detection software module is assigned to the ink jet device.

According to the present invention, it is further preferred that in order to eject a droplet out of the nozzle, an actuation pulse is applied by the transducer and the detection means detects the behaviour of the transducer during and/or after the application of the actuation pulse. This can very preferably be done by applying a Fourier transformation to the signal of the transducer during or after the actuation pulse and by analysing the signal of the transducer in the frequency domain.

Very preferably, the inkjet device comprises a multi-nozzle print head. Such a print head enables a plurality of droplets to be ejected from a single print head. This speeds up the printing process.

It is much preferred according to the present invention to use an ink jet device which further comprises a print table and a printing bridge, the print table being mounted moveably relative to the printing bridge along a first direction and the print head being mounted to the printing bridge such that the print head is moveable relative to the printing bridge along a second direction. Thereby, it is possible to print or release droplets of a substance to a large area of application such that the production of printed products can be made quite cost-effective, because large substrates or individual substrates can be printed as one batch.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the spots or the droplets do not only lie on the surface, but also penetrate into the membrane.

In a still further embodiment of the present invention, the substrate comprises a plurality of substrate areas, each substrate area preferably being a separated membrane held by a membrane holder. Thus, a plurality of separated membranes can be produced by the use of the inventive ink jet device.

Further, preferably, the substrate comprises a plurality of substrate locations, the substrate locations being separated from each other by at least the average diameter of a droplet positioned at one of the substrate locations. Thus, it is possible to precisely and independently locate different droplets of a substance at precise locations on the substrate. It is also possible and advantageous to place a plurality of droplets at one and the same substrate location.

Very preferably, the substance is a solution in solvents like water or alcohols and the like, where different molecules or different compounds, especially bio-molecules, are present. Other components can be active in the solution for adjusting physical parameters like surface tension or viscosity in order to optimise the printing process.

The present invention also includes a method of discriminating between a plurality of substances on a substrate, using an ink jet device comprising at least a print head comprising a nozzle, the device further comprising at least a transducer provided to eject a droplet out of the nozzle, wherein a detection means is assigned to the ink jet device such that the substances are discriminated from each other by detecting the behaviour of the transducer. It is thus possible to detect which one of a plurality of different substances or fluids is inside the print head. By virtue thereof, it is possible to provide for a higher degree of accuracy of the printing process in the situation where different substances are to be printed in a specified manner.

According to the invention, it is preferred that the substances are discriminated from each other by means of a measurement of at least one parameter related to the viscosity of the substances. The viscosity of the liquids or substances to be printed is a characteristic which can be very advantageously manipulated in order to conduct the method according to the present invention, because the viscosity is a characteristic which is relatively stable and which can be set relatively easily without affecting e.g. sensitive parts of the substance to be printed, e.g. bio-molecules.

According to the present invention, it is preferred that the at least one parameter is the impedance of the transducer and/or the gain of the transducer and/or the key tone frequency of the transducer. These parameters are easily accessible by means of the detection means assigned to the print head.

It is furthermore preferred according to the present invention that a droplet is ejected out of the nozzle by means of an actuation pulse applied by the transducer, and the detection means detects the behaviour of the transducer during and/or after the application of the actuation pulse and/or a Fourier transformation of the behaviour of the transducer during and/or after the application of the actuation pulse is performed and analysed.

It is preferred according to the present invention that a feedback loop stops the printing process if the analysis of the Fourier transformation of the behaviour of the transducer during and/or after the application of the actuation pulse cannot be related to a predefined viscosity of the substances. This has the advantage that the printing process is stopped when something goes wrong during printing (the feedback loop immediately interferes with the printing process) and that the substrate that is printed is marked (especially by software) as “incorrect” and not considered a good product. In many cases, it cannot be easily determined afterwards why the measured viscosity of a substance is not in the predefined range. An operator can maintain the print head such that it operates according to the specifications and the printing process can then be resumed. In the software, the incorrectly printed substrate is marked and removed from the batch of printed membranes.

In a still further preferred embodiment, a plurality of different substances are applied to the substrate such that a first substance is positioned at a first substrate location and the second substrate is positioned at a second substrate location. This has the advantage that by performing one and the same printing process and only exchanging the substance inside a print head, a multitude of different substances can be printed onto the substrate, which can be used in a biochemical assay cartridge.

The present invention also includes the use of an inventive ink jet device according to the present invention, wherein the substance comprises a biochemical reactant and/or a nucleic acid and/or a polypeptide and/or a protein. By using the inventive ink jet device for such a purpose, it is possible to very accurately print a certain number of substances onto a substrate without an error as to which substance is printed.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

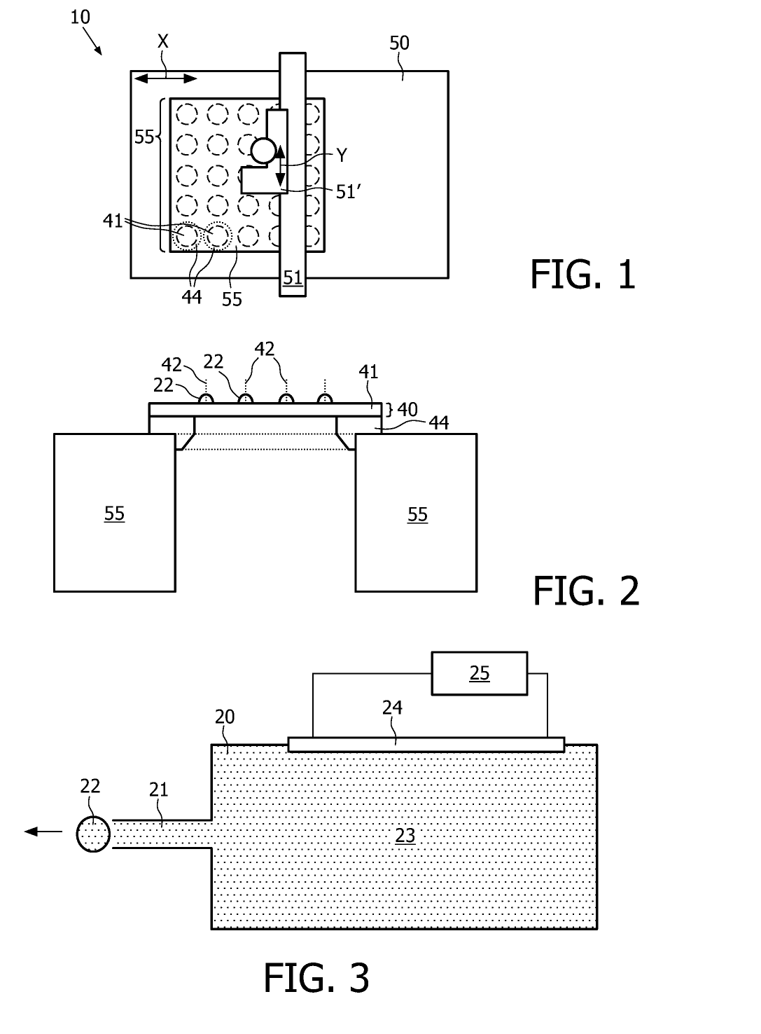

FIG. 1 illustrates schematically a top view of an embodiment of the ink jet device of the present invention,

FIG. 2 illustrates schematically a cross section through a substrate area and a membrane holder,

FIG. 3 illustrates schematically a print head with a nozzle and a detection means,

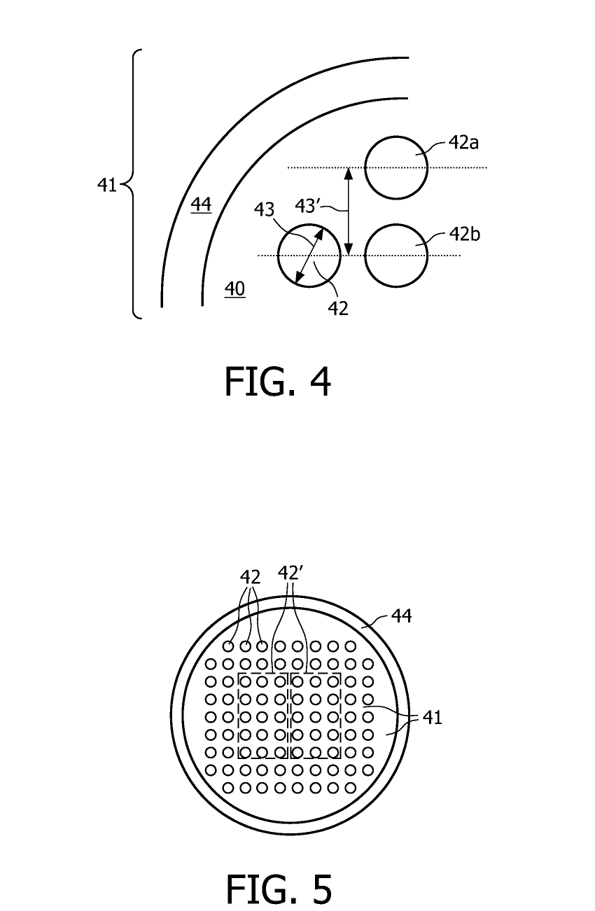

FIGS. 4 and 5 illustrate schematically a part of a substrate area together with a membrane holder and a complete membrane,

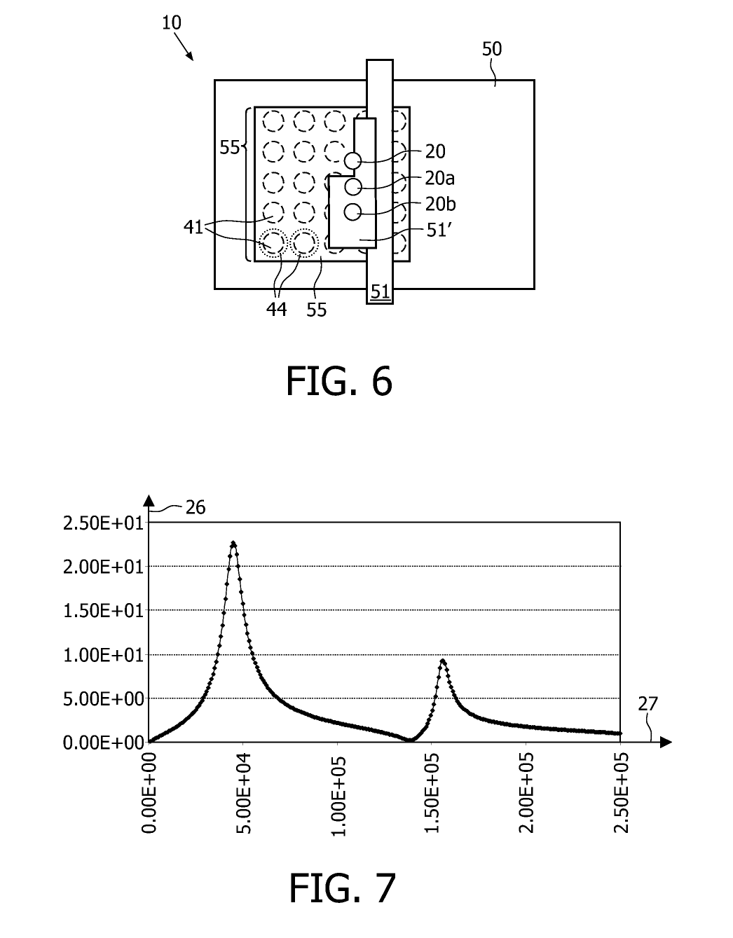

FIG. 6 illustrates schematically an embodiment of an ink jet device comprising a plurality of print heads and

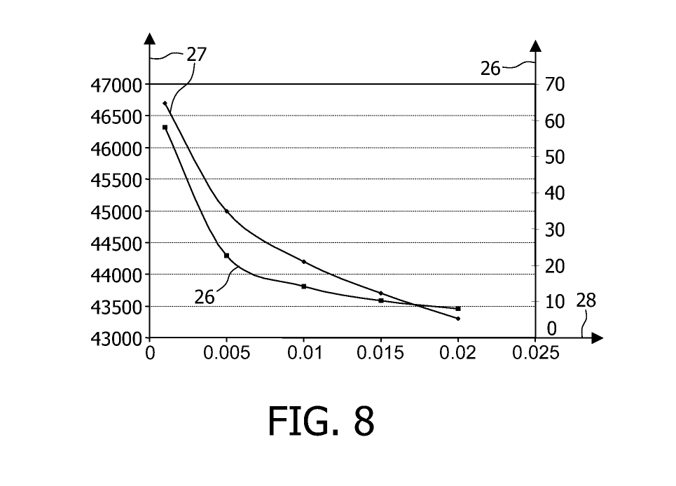

FIGS. 7 and 8 illustrate schematically different parameters related to different viscosities of different substances.

Although the present invention will be described with respect to particular embodiments and with reference to certain drawings, this description is not to be construed in a limiting sense, as the invention is limited only by the appended claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless specifically stated otherwise.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a schematic top view of the ink jet device 10 according to the present invention is shown. On a print table 50 (preferably made of heavy granite) a fixture plate 55 is mounted on a linear stage allowing for movements in the X-direction of the fixture plate 55. In this fixture plate 55, a number of membrane holders 44 with membranes 41 are positioned. The membranes 41 together form the substrate 40. Therefore, the membranes 41 could also be called “substrate 41”. For the sake of clarity, in the following, the term “substrate 40” refers to the totality of the printable area of the “membranes 41”. The membrane holder 44 is basically only a ring 44. A round membrane 41 is welded onto this ring. So, after printing, the ring 44 with spotted membrane 41 together form the final product. A printing bridge 51 is rigidly mounted relative to the print table 50 (preferably a heavy granite table). The printing bridge 51 carries the movable print head holder 51′. The stage with the fixture plate 55 is moveable along a first direction, the X-direction. A print head 20 is mounted to the movable print head holder 51′ such that it is moveable along a second direction, the Y-direction, relative to the printing bridge 51. According to the present invention, it is preferred that the first direction (X-direction) and the second direction (Y-direction) are orthogonal. As a result, the print head 20 can be moved over a certain area of the print table 50 and can release droplets of a substance which is stored in the print head 20 or in a reservoir (not shown) near the print head 20. The membranes 41 are mounted in the fixture plate 55, also called registration plate 55, at a uniform distance from each other in the X-direction and uniform a distance in the Y-direction. The distance in the X-direction may differ from the distance in the Y-direction.

The substrate 40 may be made of a bio-active membrane used for the detection of infectious diseases. Diagnostics of such diseases demands for a very high reliability of the printing process. The readout of the fluorescent pattern relates diseases directly to the positions of the specific capture probes. Therefore, it is absolutely necessary to have a very reliable process for the printing of the correct substance from a plurality of different substances. Ink jet printing is a precision dosing technique without any feedback about the nature of the actually printed substance. By measuring the viscosity of the substance inside the print head 20, it is possible to check whether the substance to be printed is really the right one. In other words, the different substances are labelled by their viscosity. Viscosity can be easily tuned or changed by the choice of the solvent or mixture of solvents. In this manner, printing errors can be reduced. The operator can now maintain the print head such that it operates according to the specification, and the printing process can be resumed. Later on, the membrane with possibly the wrong substance can be removed from the batch of printed membranes 41.

The print table 50 is preferably provided in the form of a granite table. Alternatively, another very heavy material can be used. According to the present invention, the print table 50 should be arranged in an environment which is substantially free of vibrational disturbances. A precision linear stage is mounted relative to the granite table (print table 50) and a fixture plate 55 mounted on the stage moves, by definition, in the first direction (X-direction). Another precision linear stage is mounted on the bridge 51 and guides the print head holder 51′, by definition, in the second direction (Y-direction).

In FIG. 2, a schematic representation of a cross sectional view of an individual substrate membrane holder 44 and a part of the fixture plate 55 is shown. The membrane holder 44 carries one membrane 41 as a part of the substrate 40. Said membrane 41 is also referred to as substrate area 41. Each individual membrane holder 44 is located on the fixture plate 55 that is fixedly mounted on a linear stage, allowing for a linear movement in the X-direction relative to the granite table (print table) 50. On the substrate 40, i.e. on each membrane 41, a plurality of substrate locations 42 are provided such that any two individual dots (schematically shown by reference sign 22 in FIG. 2) can be located at a distance from one another. A dot can be formed out of one droplet dispensed by the print head or is built-up of a plurality of droplets of the same substance. Thus, it is possible to dispense or position a different kind of substance at each of the substrate locations 42.

In FIG. 3, a print head 20 with a nozzle 21 and a detection means 25 is schematically shown. The print head 20 comprises a transducer 24. The transducer 24 is preferably a piezoelectric transducer 24. Generally, an electromechanical transducer 24 being able to provide mechanical waves inside the print head 20 can be used as a transducer 24. The transducer 24 can be actuated by an activation pulse (not shown) provided by a control unit (not shown). The detection unit 25 or detection means 25 is able to detect the behaviour of the transducer 24, which is in turn influenced by the behaviour of the print head 20 and/or the print head 20 together with the fluid or the substance 23 inside the print head 20.

According to the present invention, a plurality of substances 23, 23a, 23b can be filled into the print head 20. This is done, for example, by means of a further duct (not shown) of the print head 20 to which a vacuum pump (not shown) can be connected. If the print head is moved such that the nozzle 21 held inside a reservoir (not shown) of a first substance 23 and the vacuum pump are actuated, the first substance 23 can be sucked into the print head 20. Then printing of the first substance 23 is performed. In this process, the transducer 24 is actuated by an actuation pulse such that a droplet 22 is ejected from the nozzle 21 of the print head 20. During the actuation pulse and/or after the actuation pulse, a measurement of the behaviour of the print head 20 and/or the transducer 24 is performed by the detection means 25. The detection means 25 is provided preferably in the form of a circuit and/or a software module being able to provide and/or measure parameters related to a property of the first substance 23 inside the print head 20. According to the invention, the measured property is preferably the viscosity of the first substance 23. Thus, it is possible to label the different substances 23, 23a, 23b or different fluids 23, 23a, 23b by their different viscosities. This is done relatively easily. By detecting these different viscosities acoustically, i.e. by means of detecting the (acoustic) behaviour of the print head 20 filled with the respective substance 23, 23a, 23b, it is possible to check (at any point in time during the printing process and especially directly during and/or after printing an individual droplet) whether the right fluid or substance 23, 23a, 23b is printed on the right spot or substrate location.

In FIG. 4, a part of a membrane 41 or substrate area 41 is shown in a top view. On the substrate area 41 are defined a plurality of substrate locations 42, 42a, 42b. The substrate locations 42, 42a, 42b are the locations where the droplets 22 are to be positioned by the ink jet device 10 according to the present invention. It is also possible to place a plurality of droplets of the same substance on a single substrate location 42. The droplets 22 which have been ejected by the print head 20 and which have landed on the substrate 40 will cover a certain dot area or spot around the substrate locations 42, 42a, 42b with an average diameter 43 which is smaller than the respective distance 43′ (or pitch) of the substrate locations 42, 42a, 42b from one another.

In FIG. 5, a top view of a substrate area 41 is shown where a plurality of substrate locations 42 are represented by small circles. According to the present invention, many different substances can be positioned at these different substrate locations 42 in order to use the membrane of the substrate area 41 for diagnostic purposes. According to the present invention, it is possible to define several groups 42′ of substrate locations 42 in order to perform a complete set of tests within one group 42′ of substrate locations 42 and their respective substances.

In FIG. 6, a further embodiment of the ink jet device 10 of the present invention is schematically and partly shown. The printing bridge 51 is provided with a further print head 20a and a third print head 20b in addition to the print head 20.

In the embodiment according to FIG. 6, up to three or more single-nozzle print heads 20, 20a, 20b mounted rigidly on the linear stage on the bridge 51 move, by definition, in the second direction (Y-direction). The print heads 20, 20a, 20b can be moved to any position on the substrate 40 by simultaneously moving the substrate 40 along the X-direction and/or the printing bridge 51 together with the print heads 20, 20a, 20b along the Y-direction. In order to minimize the motion of the print head holder, the distances between the print heads 20, 20a, 20b are as close as possible to the distance between the membranes 41 in the Y-direction. The print heads can be filled with the same fluid/substance 23, 23a, 23b or with a different fluid/substance 23, 23a, 23b. By the use of more than one print head 20, a decrease in print time can be obtained when a number of single-nozzle print heads are used in parallel.

On a substrate area 41, for example 130 spots or substrate locations 42 can be provided where droplets 22 can be printed, each droplet needing a volume of e.g. around 1 nl. The diameter 43 of the spots or the droplets 22 is for example 200 μm and they are placed in a pattern with a pitch of e.g. 400 μm. Of course, it is also possible to provide more (up to 1000) and smaller spots necessitating only a smaller pitch of, for example, 300 μm or only 200 μm, 100 μm or 50 μm. The 130 spots are printed, for example, with a single print head 20 which is provided with different substances 23. For example, on the fixture plate 55, 140 membrane holders 44 are arranged which are processed in one batch of printing by the ink jet device 20. The pitch 43′ of the droplet spots is set in the range of 10 to 500 μm according to the present invention. The diameter 43 of the spots of the droplets 22 is in the range of about 20% to 70% of the actual pitch 43′. The volume of the droplets 22 has to be adapted to the preferred size of the spot and to the material of the substrate 40 used (e.g. dependent on where the substrate strongly or weakly absorbs the substance applied). Typically, the volume of the droplets 22 is about 0.001 nl to 10 nl.

An essential feature of the present invention is the measurement—by means of the detection means—of the acoustic response just by using the transducer 24 of the print head 20 as a pressure sensor. By virtue thereof, no extra means have to be built in the print head 20. Viscosity labelling of the different substances 23, 23a, 23b to be printed can be done in the laboratory of the manufacturer, thereby making mistakes later on almost impossible.

In FIGS. 7 and 8, different parameters related to different viscosities of different substances are schematically shown. FIG. 7 shows the typical calculated response of a sample print head 20 as schematically shown in FIG. 3. The print head 20 has a nozzle 21 having e.g. a diameter of 50 μm and a length of 43 μm; the pump chamber (i.e. print head 20) is e.g. 3.6 mm long and its cross section measures 0.36 mm². The pump chamber or print head 20 is connected to the ink reservoir (not shown) by means of a damping channel (not shown) with a length of e.g. 1.5 mm and a diameter of 60 μm. A part of the wall of the pump chamber or print head 20 can be set in motion by means of the transducer, especially a piezo-plate transducer 24. The pump or print head 20 is filled with a substance 23 or fluid 23 with a density of e.g. 1000 kg/m³, a viscosity of e.g. 0.005 Pas, a surface tension of e.g. 0.04 N/m and a speed of sound corrected for the compliance with the environment of 1000 m/s. These values result in a key tone (first resonance) of about 45 kHz and a first overtone (second resonance) of about 155 kHz (abscissa: frequency). The system is driven at constant amplitude and the gain 26 at resonance is given (in arbitrary units) at the ordinate 26. In FIG. 8, the dependency of the key tone frequency 27 (given in Hz at the left side ordinate) and the gain 26 (given in arbitrary units at the right side ordinate) is shown. The abscissa 28 in FIG. 8 is the viscosity 28 axis. This shows that upon a change in viscosity from 0.001 Pas to 0.01 Pas, the key tone frequency drops from e.g. 46.7 kHz to 44.2 kHz, a change of 2.5 kHz. Per change of 0.001 Pas in the viscosity 28, a change of 200 to 250 Hz is observed in the key tone frequency 27. This is an easily detectable difference. Moreover, the drop in the gain 26 (at key tone frequency) is even more pronounced. Using a viscosity range (e.g. from 1 to 10 mPas) that can be used for printing, at least 10 different fluids or substances 23, 23a, 23b can be identified. Of course, in order to keep the viscosity of the different substances 23, 23a, 23b at the correct and detectable value, evaporation of solvent of the substances 23, 23a, 23b resulting in a change of viscosity 28 should be avoided.

1. Ink jet device (10) for releasing controllably a plurality of substances (23, 23a, 23b) onto a substrate (40), the device (10) comprising at least a print head (20) comprising a nozzle (21), and the device (10) further comprising at least a transducer (24) provided to eject a droplet (22) out of the nozzle (21), wherein a detection means (25) is assigned to the ink jet device (10) such that the substances (23, 23a, 23b) are discriminable from each other by means of the detection of the behaviour of the transducer (24).

2. Ink jet device (10) according to claim 1, wherein the substances (23, 23a, 23b) are discriminable from each other by means of a measurement of the viscosity (28) of the substances (23, 23a, 23b).

3. Ink jet device (10) according to claim 1, wherein the transducer (24) is a piezoelectric transducer (24).

4. Ink jet device (10) according to claim 1, wherein the detection means (25) is an electronic detection circuit assigned to the ink jet device (10), or wherein the detection means is detection software assigned to the ink jet device (10).

5. Ink jet device (10) according to claim 1, wherein in order to eject a droplet (22) out of the nozzle (21), an actuation pulse is applied by the transducer (24), and wherein the detection means (25) detects the behaviour of the transducer (24) during and/or after the application of the actuation pulse.

6. Ink jet device according to claim 1 wherein the inkjet device (10) comprises a multi-nozzle print head (20).

7. Ink jet device (10) according to claim 1, wherein the ink jet device (10) further comprises a print table (50) and a printing bridge (51), a stage with fixture plate (55) which is movable relative to the print table (50) along a first direction (X-direction), and the print head (20) mounted on a movable print head holder being mounted to the printing bridge (51) such that the print head (20) is movable relative to the printing bridge (51) along a second direction (Y-direction).

8. Ink jet device (10) according to claim 7, wherein the first direction (X-direction) and the second direction (Y-direction) are orthogonal.

9. Ink jet device (10) according to claim 1, wherein the substrate (40) is a flat substrate, a structured substrate, a coated substrate or a porous membrane (41), preferably a nylon membrane.

10. Ink jet device (10) according to claim 1, wherein the substrate (40) comprises a plurality of substrate areas (41), each substrate area (41) preferably being a separated membrane (41) held by a membrane holder (44).

11. Ink jet device (10) according to claim 1, wherein the substrate (40) comprises a plurality of substrate locations (42, 42a, 42b), the substrate locations (42, 42a, 42b) being separated from each other by at least the average diameter (43) of a droplet (22) positioned at one of the substrate locations (42, 42a, 42b).

12. Ink jet device (10) according to claim 11, wherein a plurality of droplets (22) are superposed at one substrate location (42, 42a, 42b).

13. Method of discriminating between a plurality of substances (23, 23a, 23b) on a substrate (40), using an ink jet device (10) comprising at least a print head (20) comprising a nozzle (21), the device (10) further comprising at least a transducer (24) provided to eject a droplet (22) out of the nozzle (21), wherein a detection means (25) is assigned to the ink jet device (10) such that the substances (23, 23a, 23b) are discriminated from each other by detecting the behaviour of the transducer (24).

14. Method according to claim 13, wherein the substances (23, 23a, 23b) are discriminated from each other by means of a measurement of at least one parameter (26, 27) related to the viscosity (28) of the substances (23, 23a, 23b).

15. Method according to claim 14, wherein the at least one parameter (26, 27) is the impedance of the transducer (24).

16. Method according to claim 14, wherein the at least one parameter (26, 27) is the gain (26) of the transducer (24) and/or the key tone frequency (27) of the transducer (24).

17. Method according to claim 13, wherein a droplet (22) is ejected out of the nozzle (21) by an actuation pulse applied by the transducer (24), and wherein the detection means (25) detects the behaviour of the transducer (24) during and/or after the application of the actuation pulse.

18. Method according to claim 17, wherein a Fourier transformation of the behaviour of the transducer (24) during and/or after the application of the actuation pulse is performed and analysed.

19. Method according to claim 18, wherein a feedback loop stops the printing process if the analysis of the Fourier transformation of the behaviour of the transducer (24) during and/or after the application of the actuation pulse cannot be related to a predefined viscosity (28) of the substances (23, 23a, 23b).

20. Method according to claim 13, wherein a plurality of different substances (23) are applied to the substrate (40) such that a first substance (23a) is positioned at a first substrate location (42a) and a second substance (23b) is positioned at a second substrate location (42b).

21. Use of an ink jet device (10) according to claim 1, wherein the substance (23) comprises a biochemical reactant and/or an oligonucleotide, and/or a nucleic acid and/or a polypeptide and/or a protein and/or a cell and/or an antibody.
